(19) United States
(12) Patent Application Publication
(10) Pub. No.: US 2007/0087153 A1
(43) Pub. Date: Apr. 19, 2007

(54) Electrically conductive release liner

(76) Inventors: Anthony Brian Port, Collinsville, VA (US); Janet Yeatts, Ruffin, NC (US)

Correspondence Address: PAUL E. MILLIKEN, 9061 WALL STREET, NW, MASSILLON, OH, 44646-1676, US

(21) Appl. No.: 11/545,194

(22) Filed: Oct. 10, 2006

Related U.S. Application Data
(60) Provisional application No. 60/726,495, filed on Oct. 13, 2005.

(51) Int. Cl. B32B 33/00

(52) U.S. Cl. 428/40.1; 428/412

(57) ABSTRACT

A release liner 10 comprising a polymeric film substrate 11, typically PET film, having a transparent layer 12 of electrically conductive polymer, preferably a PEDOT-PSS (Polyethylenedioxythiophene/polystyrenesulphonic acid), formed on one side thereof, the conductive polymer layer 12 being over coated with a transparent layer 13 of a curable silicone polymer or copolymer.

### RELATED US APPLICATIONS

This is a non-provisional application of provisional application Ser. No. 60/726,495 filed Oct. 13, 2005 and now pending.

### FIELD OF THE INVENTION

This invention relates to a release liner of the type which is easily peelable from an adhesive surface and which is electrically conductive and in particular is useful for the dissipation of electrostatic charge.

### BACKGROUND OF THE INVENTION

Release liners are frequently used in the manufacture of semi-conductor wafers. For example in U.S. Pat. No. 4,961,804 there is described a support film having a release layer on one side with conductive adhesive coated onto the release layer for the bonding of semi-conductor wafers to the support film. The release layer allows for the separation of the wafer/adhesive from the support film. In one embodiment the adhesive is also covered by a removable release liner prior to attachment of the wafer.

The use of a peelable conductive release layer helps prevent dust or other foreign bodies from being attracted to the surface of the wafer when it is removed from the support film for subsequent use.

The release liner may be made conductive in a number of different ways, for example in JP6344514, the support film is coated with a polymeric film layer containing conductive ATO particles in a polymeric binder, which is then coated with a silicone resin layer. U.S. Pat. No. 6,115,683 describes a conductive polymeric film layer which contains carbon black particles.

JP5024156 discloses a method of forming an antistatic silicone release film from a coating comprising organosilanes and a metallic compound.

In another solution disclosed in DE 1961 2367, the silicone release layer is formed from a silicone composition which contains electrically conductive metal oxides.

One problem arising from the use of silicone release liners is the transfer or migration of silicone to the adhesive with which the release liner is in contact. Release liners used in the electronics industry have maximum for silicone extractables set at 400 nanogram/sq cm under the Seagate specification 20800012-001 Rev.B. Furthermore in some applications it is necessary for the release liner to be transparent allowing items to which it is adhered to be observed.

The present invention provides a release liner, preferably a transparent release liner, which can dissipate static electricity and which ameliorates problems due to silicone migration. Such a release liner is an optimisation of conflicting requirements, for example the need for good conductivity may conflict with the need for optical transparency, and the need for easy release properties may need to balanced with silicone migration.

### STATEMENTS OF THE INVENTION

According to the first aspect of the present invention there is provided a release liner comprising a polymeric film substrate having a transparent layer of electrically conductive polymer formed on one side thereof, the conductive polymer layer being over coated with a transparent layer of a curable silicone polymer or copolymer. The polymeric film substrate may comprise one of polycarbonate, acrylic, polypropylene and PET, the preferred film being PET. The film substrate is preferably a PET (polyethylene terephthalate) film about 2 mil (50 microns) thick and which may contain a UV absorbing material as is disclosed in U.S. Pat. No. 6,221,112. Preferably the release film substrate is transparent.

The electrically conductive polymer may comprise one of a polyaniline available from Panipol of Finland, a polypyrrole available from DSM of the Netherlands, or a PEDOT-PSS polymer available from Agfa Gevaert of Belgium or Bayer of Germany. The preferred electrically conductive polymer is a PEDOT-PSS (Polyethylenedioxythiophene/polystyrenesulphonic acid) supplied under the tradename “Orgacon Pedot”. The sheet resistivity of the PEDOT-PSS layer will depend on the dry film thickness of the conductive layer. The thicker the layer the lower is the resistivity. For the dissipation of anti-static the dry film thickness should be about 0.03μ (microns) with a resistivity of between 4-8 ×10⁴ Ohms per square at 100v and for a conductive liner the dry film thickness thickness is preferably less than 0.5μ, and more preferably between 0.2-0.3μ, with a resistivity of between 300 ohms per square—50,000 ohms per square at 0.5v.

The silicone polymer may comprise one of a UV cured epoxy functional silicone (available from Rhodia Silicones North America of Rock Hill, S.C.), tin catalysed condensation cure silicones (Available from GE Silicones), a platinum catalysed addition cure silicone and a platinum cured fluorosilicone (available from Dow Corning). For electronic applications the preferred material is a UV or electron beam cured epoxy silicone copolymer.

The transparent silicone layer typically has a dry film thickness of between 100 to 3600 Angstroms.

For the dissipation of anti-static, the release liner has a resistivity (measured through the silicone layer) of between 1.0×10⁷ to 40×10⁸ ohms/square at 100 volts, preferably about 5.0×10⁷ ohms/square at 100 volts. For a conductive liner, the resistivity of the release liner should be in the order of 300-100,000 ohms per square, preferably about 5×10⁴ Ohms per square at 0.5v.

The optical properties of the release liner are such that it has a % VLT of at least 75%, preferably greater than 80%, and a Haze value of less than 5%, and more preferably less than 2.0%

The release properties of the liner are between 3.0-16.0 g per cm , preferably about 4.0g/cm.

The silicone extractables are less that 0.3 micrograms/cm².

Release liners are typically adhered to surfaces-to-be-protected by an adhesive layer and help avoid a static discharge on removal of the liner from the adhesive layers during some manufacturing processes. Such discharges could for example result in damage to static sensitive semi-conductors, electronics equipment etc. The low silicone extractables are also especially useful in these applications.

Furthermore, static build up on the surface of adhesive layers after removal of release liner, would attract dust, dirt, foreign bodies etc to the adhesive prior to mounting or assembly. This would apply to any process where cleanliness is important for function or appearance e.g.(i) semi-conductors, electronics equipments, displays etc., (ii) wound dressings, (iii) dry mounting of films to glazing, including vehicle glazing, for solar control, glare control, impact resistance/safety, UV protection (museum or medical) or decorative purposes, (iv) adhesive lamination of two optically clear layers.

According to yet a further aspect of the invention there is provided a window film comprising an comprising a transparent polymeric film substrate having an adhesive layer on one side thereof for mounting of the window film to glazing, the adhesive layer being covered by a release liner according to the first aspect of the invention.

This would also apply in the situation where a roll of release liner is unwound during a manufacturing or assembly process. This would be especially so in any process where cleanliness is important as described above and where flammable and/or explosive atmospheres or static sensitive materials e.g. pyrotechnics are present.

Additionally, in coating and laminating processes where a silicone release liner is laminated to an adhesive coated film in a roll to roll process, it has been found that the generation and persistence of static on conventional release liner is such that it distorts the adhesive layer (via discharge or flow defects caused by the high voltage field).

Under certain conditions not entirely understood this damage and distortion occurs with conventional release liner despite the use of state of the art static dissipative equipment on the line with the consequence that the optical quality of the film produced is compromised. It is believed that an anti-static release liner will alleviate this problem.

A transparent release liner according to the invention is useful in the electronics industry. The liner may be utilised as part of a laminate in which the liner is placed over a conductive ink/adhesive layer which has on its opposite side a non-transparent conductive release liner. Electric current is applied to the two conductive outer liners causing the inner conductive ink/adhesive layer to illuminate facilitating visual inspection by way of the transparent release liner. After visual inspection the laminate may be used in further processing. This requires removal of the transparent liner without damage to the ink/adhesive layer. The silicone layer of the liner should necessarily adhere to the conductive layer of the liner more forcefully than it adheres to the conductive ink/adhesive layer. There should be little or no migration of silicone to the ink/adhesive layer.

Also according to one aspect of the present invention, there is provided a method of manufacture of an anti-static conductive release liner in which method an aqueous dispersion of conductive polymer is applied to a surface of a polymeric film substrate, and the dispersion is dried, and then coated with a liquid composition comprising a silicone polymer or silicone copolymer which is dried and cured.

The conductive polymer and silicone composition may be applied to the film substrate using direct gravure techniques.

The preferred composition for formation of the silicone layer is a UV curable epoxy functional silicone copolymer composition typically comprising by weight:

| | |
|---|---|
| 60-85% | Heptane |
| 6-10% | MEK (methyl ethyl ketone) |
| 0.15-1.0% | Initiator |
| 6.0-30% | Epoxy silicone copolymer |

Preferably the composition comprises a mixture of two different molecular weight copolymers.

### BRIEF DESCRIPTION OF THE DRAWINGS

The invention will be described by way of example and with reference to the accompanying drawings in which:

FIG. 1 is a cross-section through a release liner according to the present invention,

FIG. 2 is a cross-section through a laminate incorporating the release liner of FIG. 1,

FIG. 3 is a cross-section through a second laminate incorporating two release liners according to FIG. 1, and

FIG. 4 is a cross-section through window film having a release liner as shown in FIG. 1.

### DETAILED DESCRIPTION OF THE INVENTION

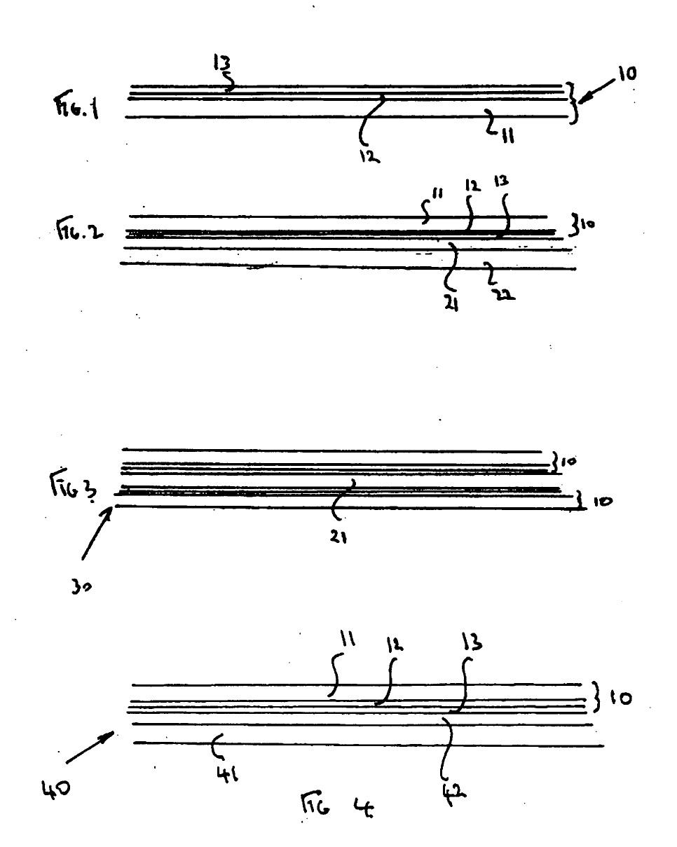

With reference to FIG. 1 there is shown a release liner 10 comprising a suitable polymeric film substrate 11 coated on one side with a layer 12 of transparent electrically conductive polymer which in turn is over coated with a layer 13 of a cured silicone polymer or silicone copolymer 13.

The film substrate 11 is preferably formed from one of polycarbonate film, acrylic film and polyester film, preferably a polyethyleneterephthalate (PET) film which may be treated with a UV absorber as described in U.S. Pat. No. 6,221,112 B so as to absorb up to 99% of UV radiation. A suitable PET film is DuPont Teijin Films' Melinex 454 or LJX 112. The film has a thickness of about 2 mil (50 microns).

Preferably the film is in a transparent form but could be made opaque for some applications.

The conductive layer 12 is formed from an aqueous composition of PEDOT-PSS (available from Agfa Gevaerts CHEMINFO number 009714). Agfa Gevaert's Safety data sheet printed 21 Nov. 2001 gives a typical composition (by weight):

| | |
|---|---|
| 0.1-1.0% | Polyethylenedioxythiophene/polystyrenesulphonic acid |
| 80-99.9% | water |
| 0.0-0.1% | surfactant |

The composition is applied to the transparent film substrate using a 2.5 Meyers rod. The film was then dried and cured for 2 minutes at 130° C.

The dry film thickness can be varied to achieve particular levels of electrical conductivity and is typically <0.5μ (microns). Table 1 below indicates surface resistivity of the polymer layer for different dry film thicknesses.

TABLE 1

| Dry film thickness | Conductivity |
|---|---|
| Microns | Ohms/Sq |
| 0.0224 | 7.4 × 10⁴ |
| 0.0271 | 6.2 × 10⁴ |
| 0.0452 | 4.1 × 10⁴ |
| 0.2715 | 4..0 × 10⁴ |

The surface resistivity at 0.5 volts using a Keithley Model 6517 A High Resistance Meter connected to a Model 8009 Resistivity Fixture. The voltage was applied for 1 minute and then the measurement recorded.

The silicone based layer is formed from a UV curable silicone polymer composition typically comprising by weight:

| | |
|---|---|
| 60-85% | Heptane |
| 6-10% | MEK (methyl ethyl ketone) |
| 0.15-1.0% | Initiator |
| 6.0-30% | Epoxy silicone copolymer |

A preferred composition for the silicone layer is given in Example 1 below in which the composition comprises by weight:

### EXAMPLE 1

| | |
|---|---|
| 71% | Heptane |
| 7% | MEK |
| 0.5% | Initiator |
| 0.5% | PC670 (available from Rhodia Silicones) |
| 21.4% | PC600 (available from Rhodia Silicones) |

PC670 and PC600 are epoxy silicone copolymers of different molecular weights and distributions.

The liquid composition is coated onto the dried conductive layer 12 using a 2.5 Myers rod and the film then dried for 1 minute at 70° C. The film was then UV cured at a linear speed of 50 ft per minute (15 meters per minute). The cured dry film thickness is between 2000-3600 angstrom , as measured by an Oxford Lab-X 3000.

The conductivity of a liner 10 having a silicone layer 13 of a thickness of 2800 Angstroms was measured though the silicone layer using a voltage of 100 volts for 1 minute, for different thicknesses of the conductive layer 12. The results are given in table 2:

TABLE 2

| Dry film thickness | |
|---|---|
| of conductive layer | Conductivity |
| Microns | Ohms/Sq |
| 0.0224 | 3.5 × 10⁹ |
| 0.0271 | 8.1 × 10⁸ |
| 0.0452 | 5.5 × 10⁷ |
| *0.2715 | 2.8 × 10⁴ |

*the conductity measured at 0.5 v for 1 minute

The transparent liner was measured for optical properties and has a VLT of 88% and a haze of less than 1%.

The haze was measured using a Hunter Laboratories Ultrascan XE and calculated according to (Diffuse Transmittance/Total Transmittance)×100 over a light range of 380-780 nm. VLT is visible light transmission calculated using CIE Standard Observer (CIE 1924 1931) and D65 Daylight.

The release force required for liner was measures as between 3.0-16.0 g per cm. Release force was measured using a ZPE-100 High Rate Peel Tester and 3M Scotch 610 tape removed at 180°@90 inches (228 cms) per minute 1 hour after application.

Silicone extractable were measured by FTIR (Fourier Transfom IR spectrophotometry) per Seagate specification 20800014-001 Rev.B, which is an industry standard specification. The silicone extractables were between 0.15-0.21 micrograms per square cms. (The above specification requires a value of <400 nanograms/cm²=0.4 microgram per square cm).

The properties of the release coating 12 may altered to meet differing peel requirements or silicone migration requirements.

As an alternative, the conductive layer 12 and silicone layer 13 may be applied to the film using direct gravure techniques using a 220 QCH cylinder and dried prior to UV curing. Example 2 below provides an alternative composition for providing a thin layer (400 A° approx) silicone release layer and comprises by weight:

### EXAMPLE 2

| | |
|---|---|
| 84.36% | Heptane |
| 9.5% | Methy ethyl ketone |
| 5.8% | PC600 |
| 0.15% | PC670 |
| 0.15% | initiator |

A transparent liner, having a silicone release layer according to Example 2 with a thickness of 385 A°, has a VLT of 88% and a haze of less than 1%.

The release force for the liner was measured as between 3.0-16.0 g/cm.

The surface resistivity at 90 volts applied for one minute was 6.5×10⁶ Ohms/Sq.

Example 3 provides a suitable tin catalysed thin layer silicone release coating and comprises by weight:

### EXAMPLE 3

| | |
|---|---|
| 11% | Toluene |
| 81.5% | Heptane |
| 7% | dimethyl siloxane polymer |
| 0.1% approx | cross linking agent |
| 0.3% approx | accelerator |
| 0.3% approx | tin catalyst |

The composition was applied using direct gravure giving a silicone coating according to Example 3 of about 210 A°. The transparent liner has optical, and release properties similar to those given above. The surface resistivity of the liner at 4.0 volts applied for 1 minute was 2.14×10⁵ Ohms/sq.

The laminate 20 shown in use in FIG. 2 has a release liner 10 according to the present invention, adhered to one side of a conductive ink/adhesive layer 21. A second conductive non-transparent release liner 22 is applied to the other side of the ink/adhesive layer 22. An electric current when applied to the two liners 10, 21 causes the ink/adhesive layer to “light up” for 1 inspection through the transparent liner 10.

A second laminate 30 is shown in FIG. 3 which is substantially similar to the laminate shown in FIG. 2 excepting that the opaque release liner is based on the release liner 10 of FIG. 1 in which the transparent PET layer 11 is replaced by an opaque PET film layer.

With reference to FIG. 4, there is shown window film 40 comprising an comprising a transparent polymeric film substrate 41 having an adhesive layer 42 on one side thereof for mounting of the film laminate to glazing in a known manner. The film substrate 41 may comprise a single layer of polymeric film, preferably PET film, typically an optically active PET film, or may be a laminate comprising a plurality of film layers. The adhesive layer 42 is covered by a release liner 10 as previously described. The liner 10 comprises a further polymeric film substrate 11 having a transparent layer 12 of electrically conductive polymer formed on one side thereof, the conductive polymer layer 12 being over coated with a transparent layer 13 of a curable silicone polymer or copolymer, the silicone polymer/copolymer layer contacting the adhesive layer 42.

What is claimed is:

1. A release liner comprising a polymeric film substrate having a transparent layer of electrically conductive polymer formed on one side thereof, the conductive polymer layer being over coated with a transparent layer of a curable silicone polymer or copolymer.

2. A release liner as claimed in claim 1 wherein the polymeric film substrate comprises one of polycarbonate, acrylic, polypropylene and PET (polyethylene terephthalate) film.

3. A release liner as claimed in claim 1 wherein the electrically conductive polymer is one of polyaniline, a polypyrrole and a PEDOT-PSS (Polyethylenedioxythiophene/polystyrenesulphonic acid).

4. A release liner as claimed in claim 3 wherein the electrically conductive polymer is a PEDOT-PSS (Polyethylenedioxythiophene/polystyrenesulphonic acid).

5. A release liner as claimed in claim 4 wherein the dry film thickness of the conductive polymer layer should be at least 0.03μ (microns) with a resistivity of between 4.0 to 8.0×10⁴ Ohms per square at 100v.

6. A release liner as claimed in claim 5 wherein said dry film thickness is less than 0.5μ, and more preferably between 0.2-0.3μ, with a resistivity of between 300 ohms per square—50,000 ohms per square at 0.5v.

7. A release liner as claimed in claim 1, wherein the silicone polymer comprises one of a UV cured epoxy functional silicone, a tin catalysed condensation cure silicones, a platinum catalysed addition cure silicone and a platinum cured fluorosilicone.

8. A release liner as claimed in claim 7, wherein the silicone polymer is a UV or electron beam cured epoxy silicone copolymer.

9. A release liner as claimed in claim 7, wherein the silicone layer typically has a dry film thickness of between 100 to 3600 Angstroms.

10. A release liner as claimed in claim 1, wherein the silicone extractables are less that 0.3 micrograms/cm².

11. A release liner as claimed in claim 1 in which the release liner has a resistivity (measured through the silicone layer) of between 1.0×10⁷ to 40×10⁸ ohms per square at 100 volts.

12. A release liner as claimed in claim 1 in which the resistivity of the release liner should be between 300-100,000 Ohms per square at 0.5v.

13. A release liner comprising a PET film substrate having a transparent layer of electrically conductive polymer comprising a PEDOT-PSS (Polyethylenedioxythiophene/polystyrenesulphonic acid) formed on one side thereof, the conductive polymer layer being over coated with a transparent layer of a UV or electron beam cured silicone polymer or copolymer, the release liner having a resistivity (measured through the silicone layer) of between 300 Ohms/square at 0.5v and 40×10⁸ ohms per square at 100 volts.

14. Window film comprising an comprising a transparent polymeric film substrate having an adhesive layer on one side thereof for mounting of the window film to glazing, the adhesive layer being covered by a release liner comprising a further polymeric film substrate having a transparent layer of electrically conductive polymer formed on one side thereof, the conductive polymer layer being over coated with a transparent layer of a curable silicone polymer or copolymer, the silicone polymer/copolymer layer contacting the adhesive layer.

15. A method of manufacture of an anti-static conductive release liner in which method an aqueous dispersion of conductive polymer is applied to a surface a polymeric film substrate, and the dispersion is dried, and then coated with a liquid composition comprising a silicone polymer or copolymer which is dried and cured.

16. A method as claimed in claim 15, wherein the conductive polymer and silicone composition may be applied to the film substrate using direct gravure techniques.

17. A method as claimed in claim 16, wherein the silicone liquid composition comprises by weight

| | |
|---|---|
| 60-85% | Heptane |
| 6-10% | MEK (methyl ethyl ketone) |
| 0.15-1.0% | Initiator |
| 5.9-30% | Epoxy silicone copolymer. |
